(19) United States
(12) Patent Application Publication
(10) Pub. No.: US 2018/0075212 A1
(43) Pub. Date: Mar. 15, 2018

(54) MEDICATION PRESCRIBING TOOL

(71) Applicant: Mayo Foundation for Medical Education and Research, Rochester, MN (US)

(72) Inventor: Alan A. Kubey, Rochester, MN (US)

(21) Appl. No.: 15/266,187

(22) Filed: Sep. 15, 2016

(51) Int. Cl. G06F 19/00; G06F 21/62; G06Q 10/08; G06Q 30/02

(52) U.S. Cl. CPC G06F 19/3456; G06F 21/6245; G06Q 30/0223; G06Q 10/087; G06F 19/3406

(57) ABSTRACT

Embodiments of the disclosure include tools such as computer systems and methods that can be used by health care providers and others such as patients, pharmacists and payers to determine value optimized prescribed medication fulfillment information such as therapeutically equivalent medications and cost-effective pharmacies or other dispensing facilities for individual users. Outputs from the tools that have this information include prescription and fulfillment information, and can be, for example, in the form of reports and visual displays. In addition to reducing burdensome costs, the tools can reduce patient non-compliance with medication regimens and improve patient outcomes.

### FIELD OF THE INVENTION

The invention relates to methods and apparatus for enhancing health care outcomes in connection with medication prescriptions.

### BACKGROUND

Health care providers often prescribe medications to treat indications such as disease states of their patients. Prescriptions are typically written for a specific total number of units of a specific medication in a specific formulation (e.g., tablets, capsules, aerosol puffs, and volumes of liquids). Each unit of the medication has a specific dose (e.g., mg for tablets and capsules and mg/ml for liquids). The prescription also typically specifies the number of units and frequency by which the medication is to be taken (e.g., two tablets, twice per day). The supply of the prescribed medication can be determined from the total number of units and the number of units and frequency by which the medication is to be taken. Prescription medication supplies are typically characterized in terms of days. For example, if the prescription was written for one hundred and twenty tablets of a medication to be taken two tablets per dose, twice per day, the supply of the prescription is thirty days. Prescriptions will typically specify whether and for how long they can be refilled. For example, in the case of medications taken for chronic disease states, the prescription may allow periodic refilling for a supply period of up to three hundred and sixty-five days.

The cost of medications can vary between pharmacies or other dispensing facilities. On-line tools such as GoodRx (goodrx.com) and WeRx (werx.org) allow patients and others to collect and compare prices of medications. For example, these tools allow a patient to enter certain prescription information and the patient's location. In response, the tools will search a database and identify prices of the medications at pharmacies located near the patient.

There remains, however, a continuing need for enhanced patient outcomes and high-value care in connection with health care delivery. Tools in the form of systems and methods that can achieve these objectives are desired.

### SUMMARY

Embodiments of the invention include a method for operating a computer system. In embodiments, the method comprises: (a) receiving prescription information representative of one or more as-written prescriptions, each as-written prescription for one or more medications, wherein the prescription information includes an as-written dose, formulation (e.g., cap, tab, liquid, etc.), frequency, quantity and search distance-related information such as search zip code for each medication of each as-written prescription; (b) receiving limitations or bounds on alternative dosing (e.g., equivalent split doses, combined smaller dose, combined split and smaller doses, and/or therapeutically equivalent non-exact conversion combinations of the proceeding alternatives), and optionally formulation, supply quantity, number of pharmacies, pharmacy fill timing, patient out of pocket cost, payer cost, and one or more search zip codes and miles from search zip codes for each medication of each as-written prescription or across multiple or all medications prescribed; (c) accessing a database, based on the above information and receiving price information including total cash price, discount total payer price, and/or discount patient out of pocket price for each medication of each as-written prescription for each of the alternative dose, formulation, and supply queries and permutations of all alternative dose, formulation, and supply quantity combinations, wherein the received price information includes prices associated with each of one or more pharmacies and a respective discount program (publically available, PBM, coupon-based, membership-based, etc.) in one or more zip codes and surround; (d) processing the price information to convert the prices to common comparison period price for each medication of each as-written prescription at each pharmacy and a comparison price of all permutations of alternative dose, formulations, supply, pharmacy, and discount combinations; (e) processing the comparison period prices to identify a low comparison period price and associated pharmacy for each medication of each as-written prescription and the low-priced permutation alternatives; and (f) providing, including optionally displaying, to a user, the identified low comparison price and associated pharmacy for each medication of each as-written prescription and/or single or collection of low comparison price pharmacy/pharmacies for some or all medications prescribed.

Embodiments include accessing a database to determine therapeutically equivalent formulation frequency (e.g. immediate release twice a day=extended release once a day) medications of one or more medications of one or more of the as-written prescriptions, and optionally of each medication of each as-written prescription. Steps (b)-(f) above are be repeated in connection with each determined therapeutically equivalent formulation medication.

Embodiments include accessing a database to determine alternative dose (or therapeutically equivalent non-exact conversion dose with bounds set in [b]) version medications of one or more medications of one or more of the as-written prescriptions and/or one or more of any determined therapeutically equivalent formulation medications. Steps (b)-(f) above can be repeated in connection with each determined alternative dose version medication.

Embodiments include accessing a database to determine equivalent generic medications of one or more medications of one or more of the as-written prescriptions and/or one or more of any determined therapeutically equivalent formulation medications and/or one or more of any determined alternative dose version medications. Steps (b)-(f) above can be repeated in connection with each determined equivalent generic medication.

Embodiments include accessing a database to determine whether any two or more medications of the as-written prescriptions are available as one or more combination medications. Steps (b)-(f) above, and/or one or more of the above steps regarding therapeutically equivalent formulation medications, alternative does version medications or equivalent generic medications, can be repeated in connection with one or more of the determined combination medications.

Embodiments include accessing a database to determine whether one or more medications of the as-written prescriptions are combination medications that include two or more component medications that are available separately. Steps (b)-(f) above, and/or one or more of the above steps regarding therapeutically equivalent formulation medications, alternative does version medications or equivalent generic medications, can be repeated in connection with one or more of the determined component medications.

Embodiments include accessing a database to determine therapeutic equivalent medications for one or more medications of one or more of the as-written prescriptions. Steps (b)-(f) above, and/or one or more of the above steps regarding therapeutically equivalent formulation medications, alternative does version medications, equivalent generic medications, combination medications or component medications can be repeated in connection with one or more of the determined therapeutic equivalent medications.

### BRIEF DESCRIPTION OF THE DRAWINGS

FIG. 1 is a diagrammatic illustration of a computer system in accordance with embodiments of the invention.

FIG. 2 is a detailed diagrammatic illustration of the databases of the computer system shown in FIG. 1.

FIGS. 3A and 3B are a flowchart illustrating a method in accordance with embodiments of the invention.

FIGS. 4a-4l are screen shots of displayed information and user interfaces in accordance with embodiments of the invention, where:

FIG. 4a shows an initial input screen.

FIG. 4b shows an initial data input.

FIG. 4c shows a medication before best-value analysis.

FIG. 4d shows the invention running a medication best-value analysis.

FIG. 4e shows a single medication's optimized best-value analysis result (e.g., lowest-priced permutation selected from all combinations of all variables described above and below, within user-define bounds).

FIG. 4f shows a single medication's optimized best-value analysis result and an in-progress therapeutic alternative medication determination.

FIG. 4g shows a partial list of therapeutic alternative options for a single original medication; in this figure alternatives are sorted by disease class (i.e. “HTN [Hypertension]”) and medication class (i.e. “ACEI [Angiotensin-Converting-Enzyme Inhibitor” or “ACEI/Thiazide”). Alternative sorting embodiments sort or sub-sort by cost, pharmacy, and additional bounding inputs (e.g., as noted in the Summary at (b)).

FIG. 4h shows a single therapeutic alternative's in-progress best-value analysis.

FIG. 4i shows a single therapeutic alternative medication's best-value analysis result.

FIG. 4j shows a comparison of an optimized medication to an optimized single alternative.

FIG. 4k shows the result of choosing a best-value option for a single medication.

FIG. 4l shows an example of an optimized outcome for three different original medications; additionally demonstrated are therapeutic class sorting (i.e. treating a 500 mg total daily dose of metformin as a 0.50% A1c Reduction therapeutic class)

FIG. 5 is a graphical representation of a set of discount prices of an as-written medication for a comparison period, over a range of supply quantities and at a plurality of different pharmacies, in accordance with embodiments.

FIG. 6 is a graphical representation of a set of discount prices for an alternative formulation medication of the as-written medication for a comparison period, over a range of supply quantities and at a plurality of different pharmacies, in accordance with embodiments.

FIG. 7 is a graphical representation of a set of discount prices for a splittable alternative dose therapeutically equivalent medication of the as-written medication for a comparison period, over a range of supply quantities and at a plurality of different pharmacies, in accordance with embodiments.

FIG. 8 is a graphical representation of a set of discount prices for a multiple unit alternative dose therapeutically equivalent tablet formulation medication of the as-written medication for a comparison period, over a range of supply quantities and at a plurality of different pharmacies, in accordance with embodiments.

FIG. 9 is a graphical representation of a set of discount prices for a multiple unit alternative dose therapeutically equivalent liquid formulation medication of the as-written medication for a comparison period, over a range of supply quantities and at a plurality of different pharmacies, in accordance with embodiments.

### DESCRIPTION OF THE INVENTION

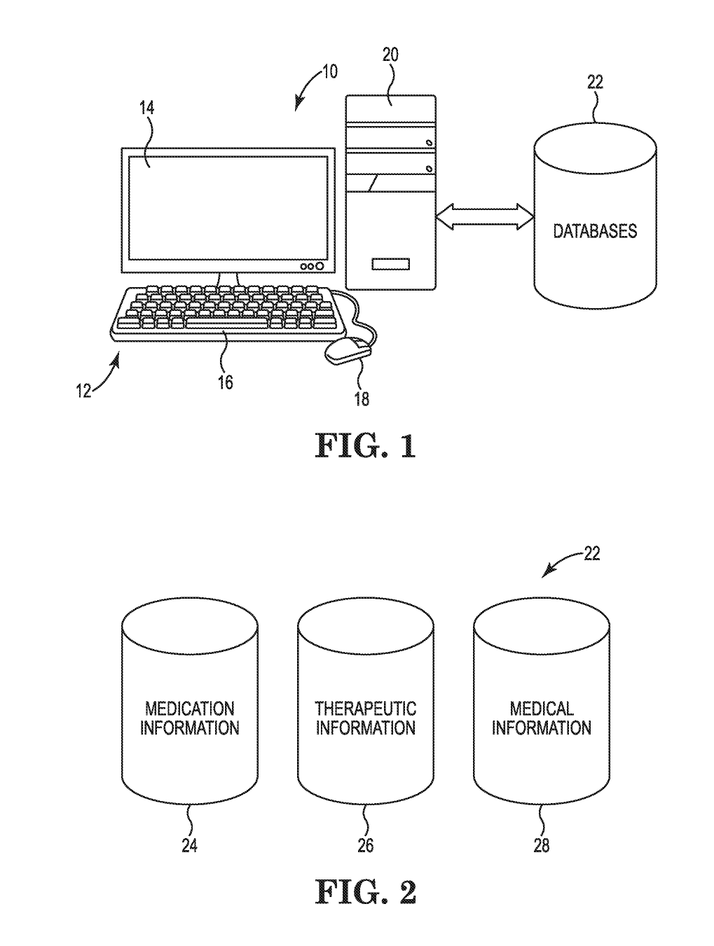

FIG. 1 is a diagrammatic illustration of a computer system 10 in accordance with embodiments of the invention. As shown, computer system 10 includes a graphical user interface 12 having a monitor 14, keyboard 16 and mouse 18. A processing system 20 that has memory (e.g., ROM and/or RAM) is coupled to the user interface 12 and optionally one or more databases 22. Programs reflecting instructions and algorithms for performing data processing methods in accordance with embodiments of the invention, and data representative of prescription information reports and visual displays in accordance with embodiments, can be stored in the memory. As described in greater detail below, information used by system 10 to generate prescription information is also stored in databases 22. Computer system 10 can be interfaced (e.g., by wireless or wired networks or software integration) to other computer or data systems (not shown) such as a health care provider's medical information system. System 10 can thereby access patients' electronic medical records that may include lists of the patients' prescribed medications (e.g., the patients' full medication regimens). Reports and other visual displays in accordance with the invention can be presented on monitor 14 or a printer (not shown). Prescription information can be transferred to the patient (e.g., the patient's computer, mobile device, via a printer) and/or to pharmacies over wired and/or wireless networks. The illustrated embodiment of computer system 10 is shown for purposes of example, and other embodiments of the invention have different or additional components, such as other user interfaces for administrators and providers that use the system, and different or additional memory, database structures and types of user interfaces.

FIG. 2 is a diagrammatic illustration of databases 22. As shown, databases 22 include a range of information components that can be generally categorized as including pharmacy information component 24, therapeutic interchange information component 26 and/or medical information component 28. Although shown as separate databases in FIG. 2, embodiments of the invention may include no functional, logical or structural distinctions between the types information stored in databases 22 or the physical structures storing the information. Different portions of databases 22 can, for example, be maintained and/or provided by different and unrelated entities, and the same or similar information components can be stored in multiple databases.

In embodiments, pharmacy information component 24 includes information on pharmacies and medications. The pharmacy information can, for example include the names, addresses and zip codes (i.e., locations) of pharmacies, as well as a list of all the medications and the prices of the medications offered by the pharmacies. The pharmacy information can also include medication cost data from within a health care institution (e.g., hospital's purchase cost for medication). The medication information can, for example, include (1) information associating different branded and generic forms of each medication (e.g., in addition to information on generic versions of hydrochlorothiazide, information on equivalent branded medications such as Microzide™), (2) the formulations (e.g., tablets, capsules, liquid, inhaler) by which each formulation of each medication is available, (3) the available doses for each of the medication formulations, (4) the supply quantities in which each of the medications is available (e.g., the available quantities for each available medication formulation and dose), and (5) prices (e.g., for each available supply quantity of each available medication formulation and dose). Other information that can optionally be included in embodiments of the pharmacy information component 24 includes information on the nature (e.g., amount) of discounts that are offered to different health care providers, networks and systems, payers such as insurance companies, sources of discount coupons that may be available to patients (e.g., cash, coupon, membership, rebates. and Medicare prices), and electronic copies of such discounts. In embodiments, for example, at least some of the above-identified types of information can be information maintained by GoodRx, Inc. of Santa Monica Calif., and can be accessed by system 10 through application programming interfaces (APIs) and data feeds available from GoodRx. Additional embodiments can, for example, include information of these types that is provided by insurers or pharmacy benefit managers (PBMs). Additional embodiments include pharmacy information such as on-shelf supply (i.e. if a patient requires same-day fill) and/or available within a specific future time period as well as patient medication filling history information that can help to identify proper and or improper medication adherence.

Therapeutic interchange component 26 includes a range of information about medications that is used by system 10. In embodiments, such information includes, for example (1) lists of classes of medications and specific medications within the classes (e.g., Class: Thiazides; Specific Medications: hydrochlorothiazide, chlorthalidone, chlorothiaxide, metolazone), (2) information on therapeutically equivalent doses for different medications between classes or within classes (e.g. therapeutic class [e.g. moderate intensity statin], therapeutic subclass [e.g. lower or higher dose of “moderate intensity statin” therapeutic class], and/or direct total daily dose conversion [e.g. atorvastatin 10 mg=rosuvastatin 5 mg]), (3) generic names for the classes and/or medications, (4) doses in which the medications are available, (5) whether the medications can be split (e.g., a tablet cut) and associated information such as how many ways the medication can be split (e.g., in two), and associated dose conversion information, including dose conversion information for non-tablet medications (e.g., conversions for vials, creams, liquids, inhalers, etc.), (6) disease indications for the medications, and (7) comorbidity and/or guideline-based prescribing information (e.g. carvedilol, metoprolol succinate, or bisoprolol noted as appropriate for left-ventricular heart failure or noting the anti-hypertension classes thiazides, angiotensin receptor blockers, angiotensin-converting-enzyme inhibitors, and calcium channel blockers as first-line agents by the Eighth Joint National Committee guidelines)

Medical information component 28 includes other medical information regarding medications and patients' medical histories that may impact users' decisions to prescribe medications, either alone and/or in combination with other medications. Examples include comorbidity information such as age, race, allergies, history or of active myocardial infarction, congestive heart failure with ejection fraction ≦40%, chronic kidney disease, clinical atherosclerotic cardiovascular disease (ASCVD), LDL >190, diabetes, a ten-year ASCVD risk score ≧7.5%, hepatic dysfunction, and other factors that are included in national-guideline-based therapeutic decision trees, as well as information characterizing those decision trees, among others.

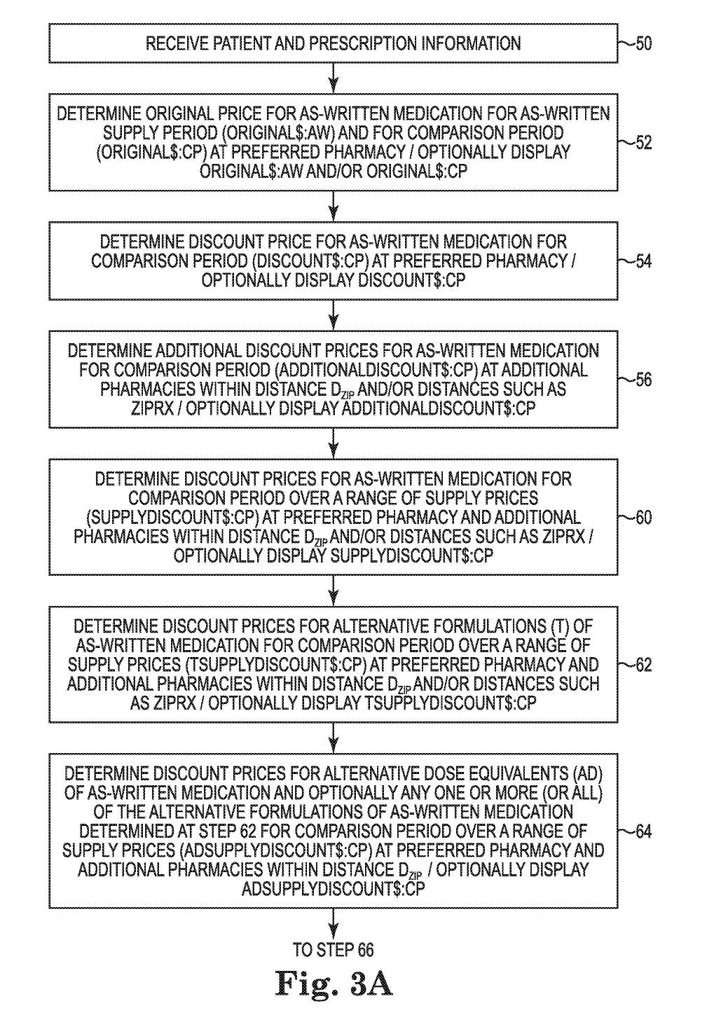

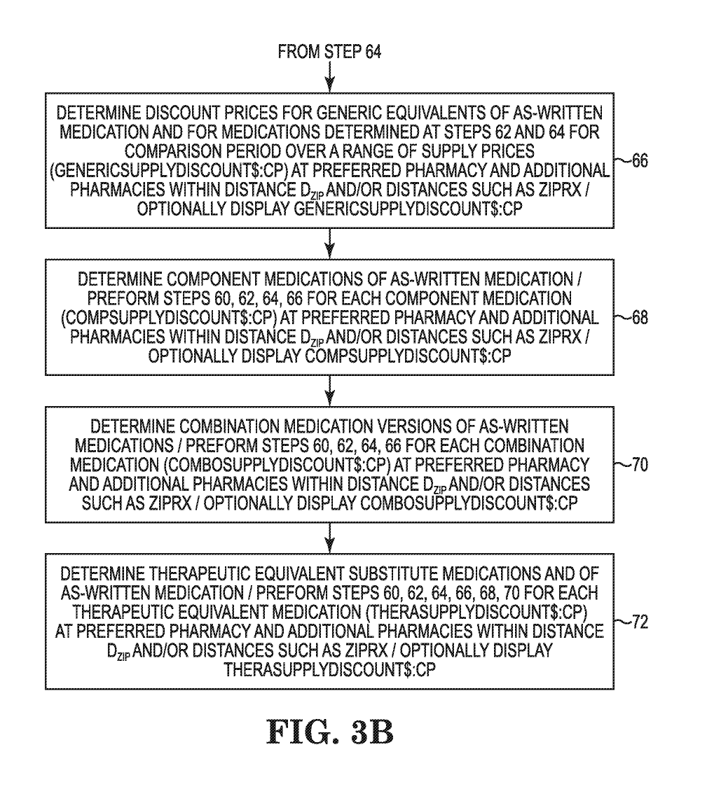

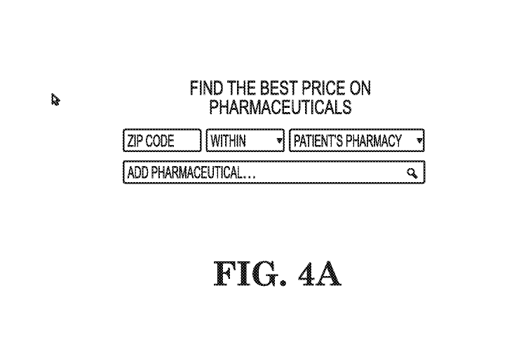

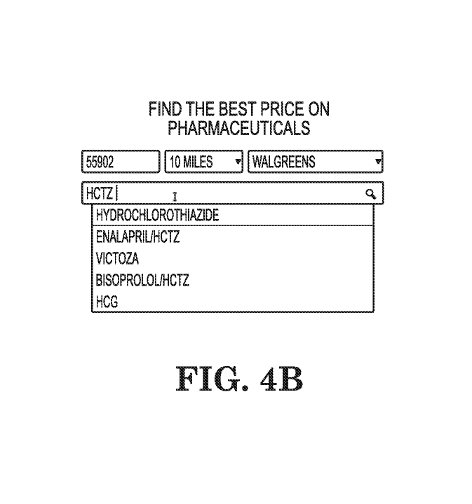

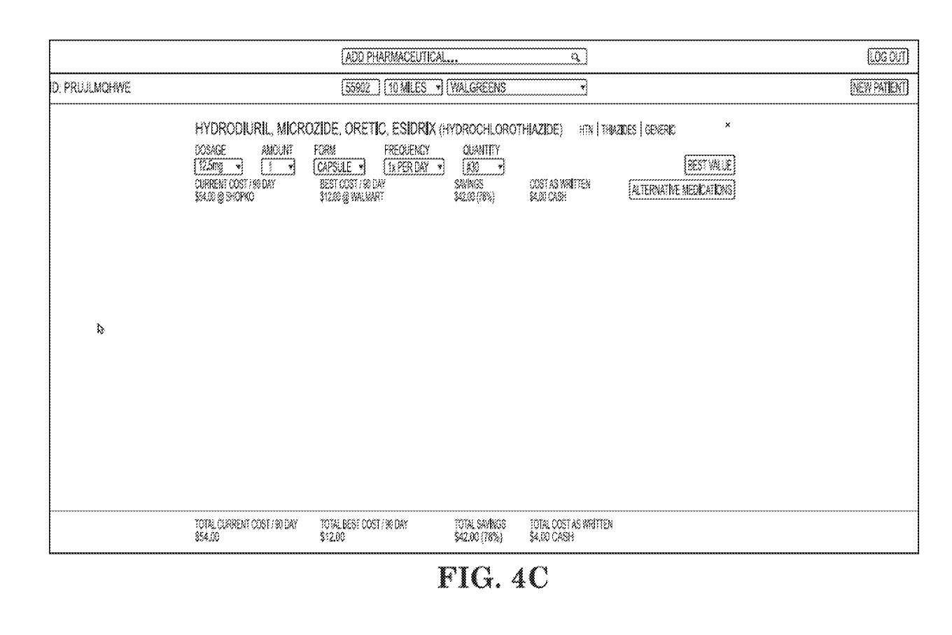

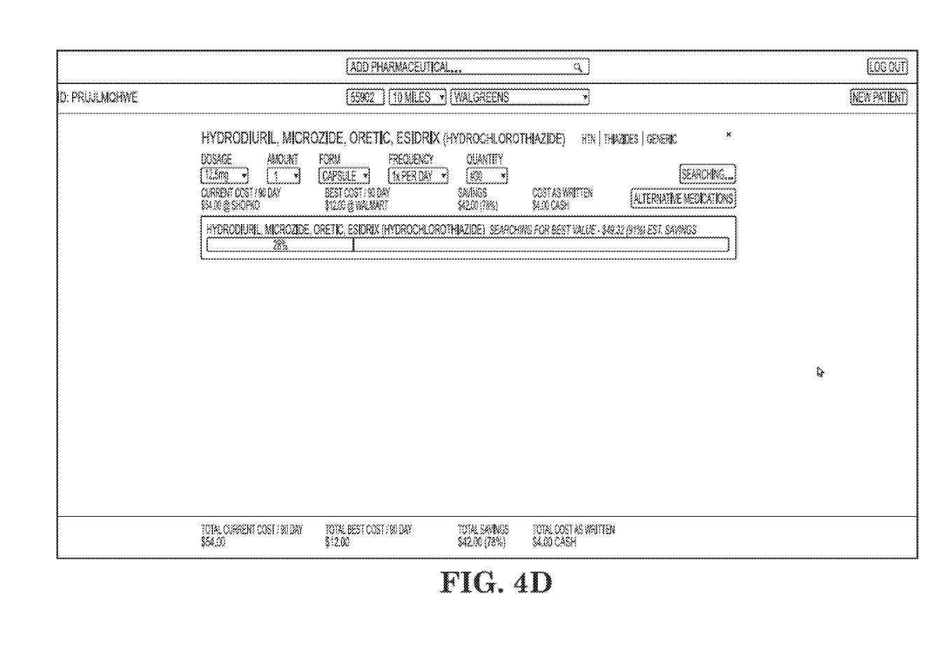

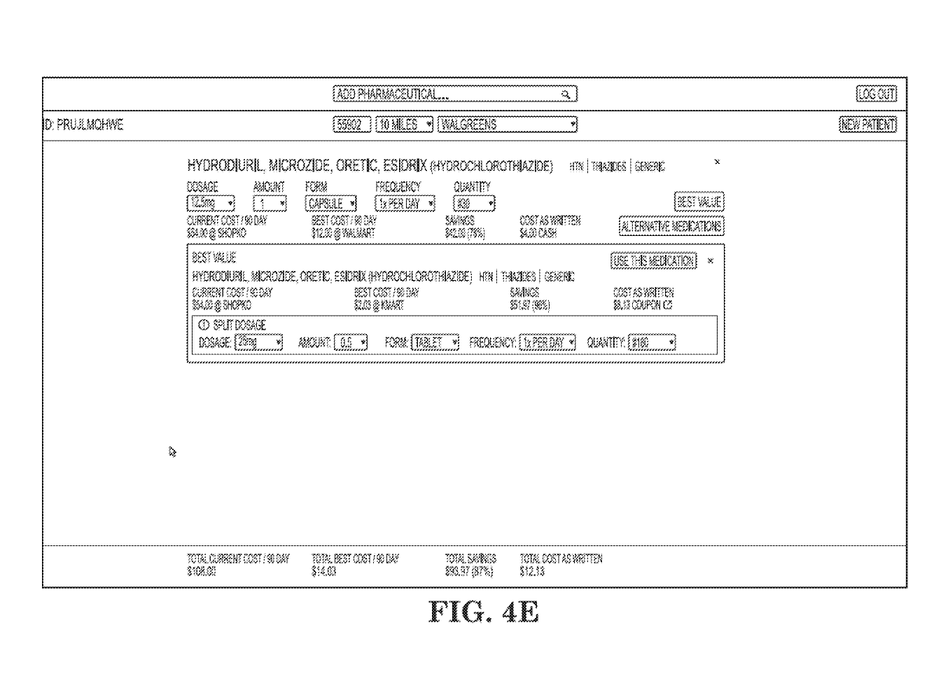

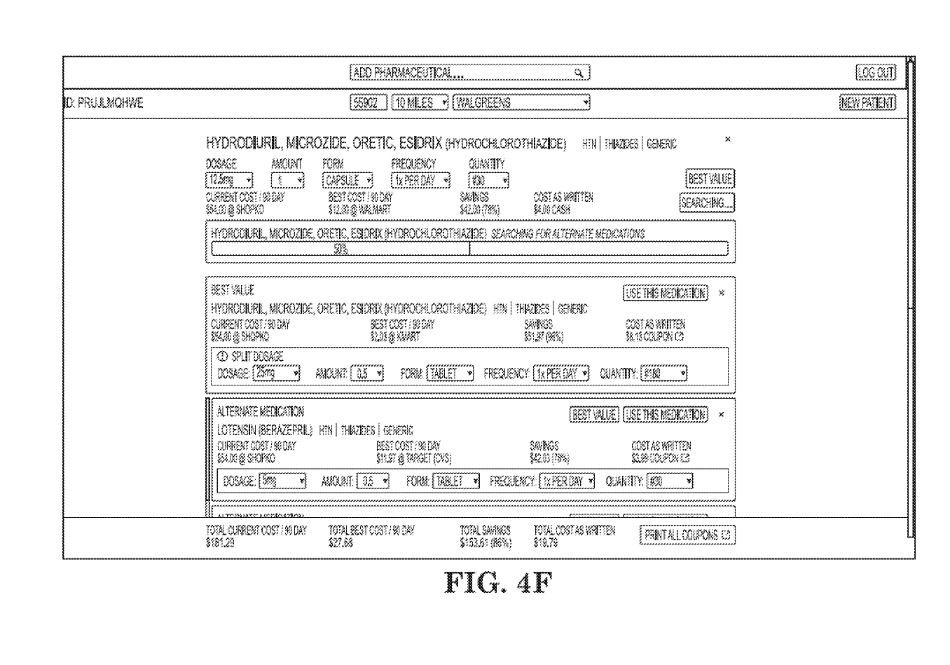

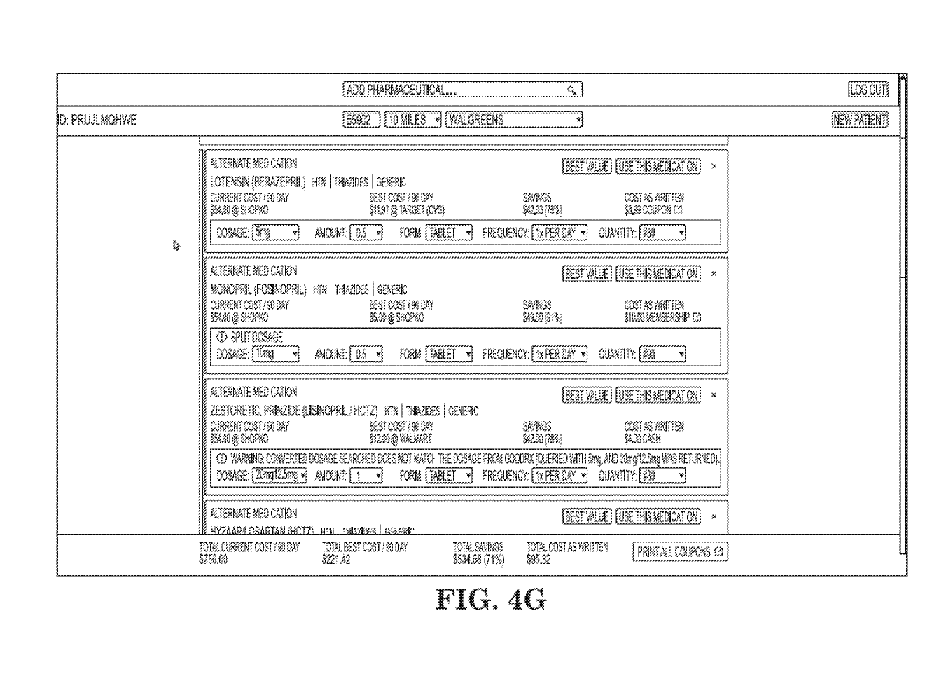

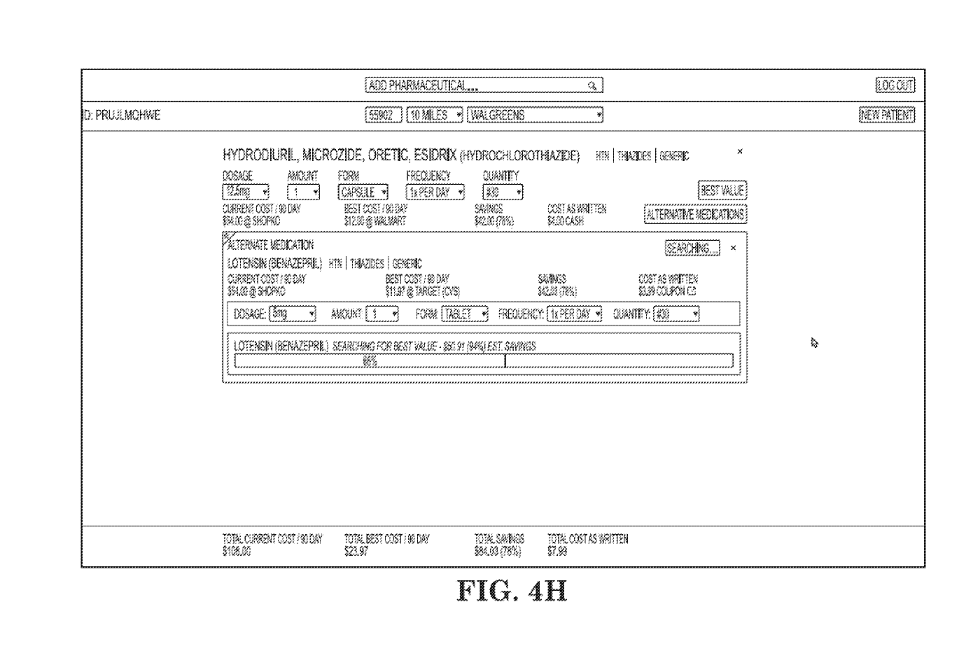

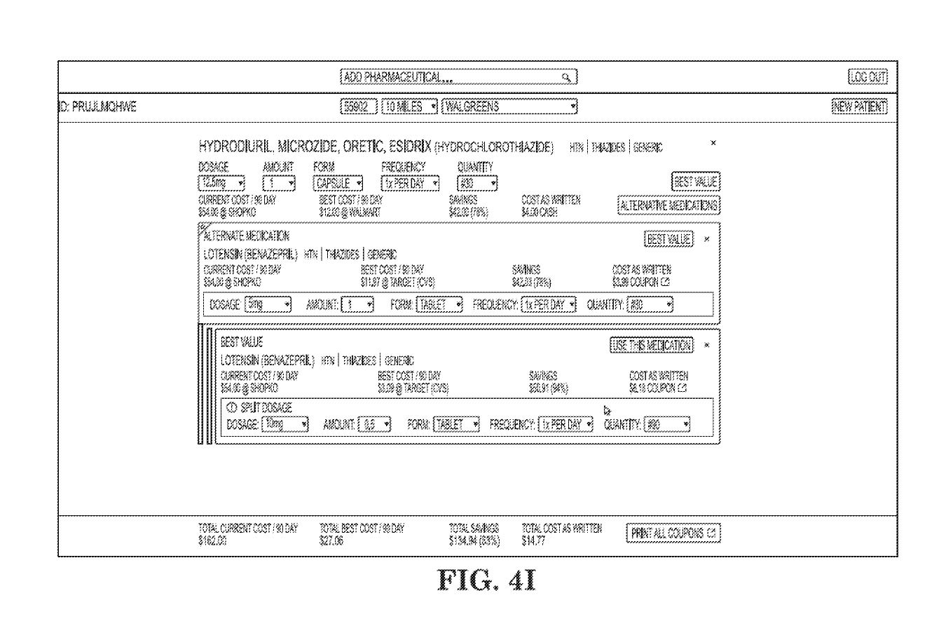

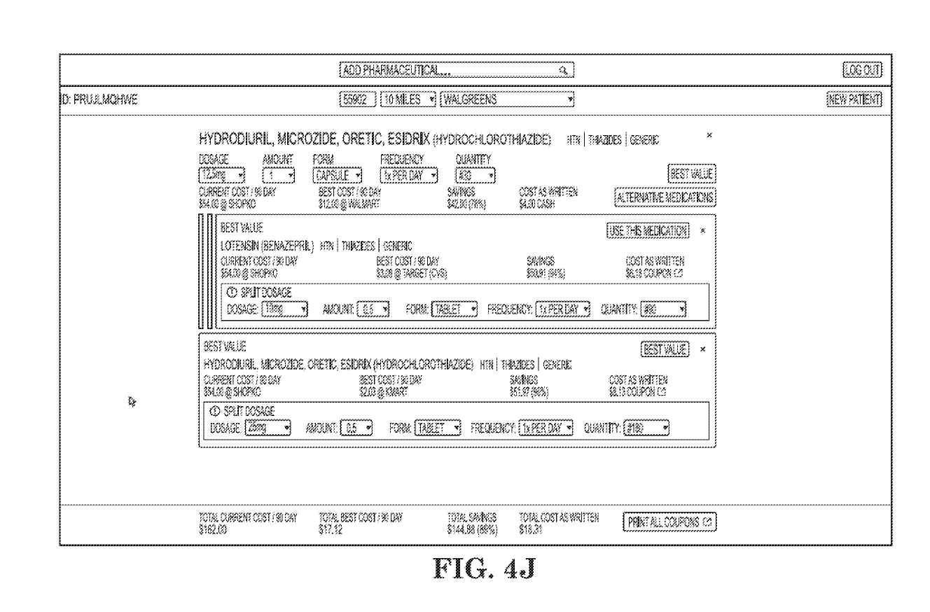

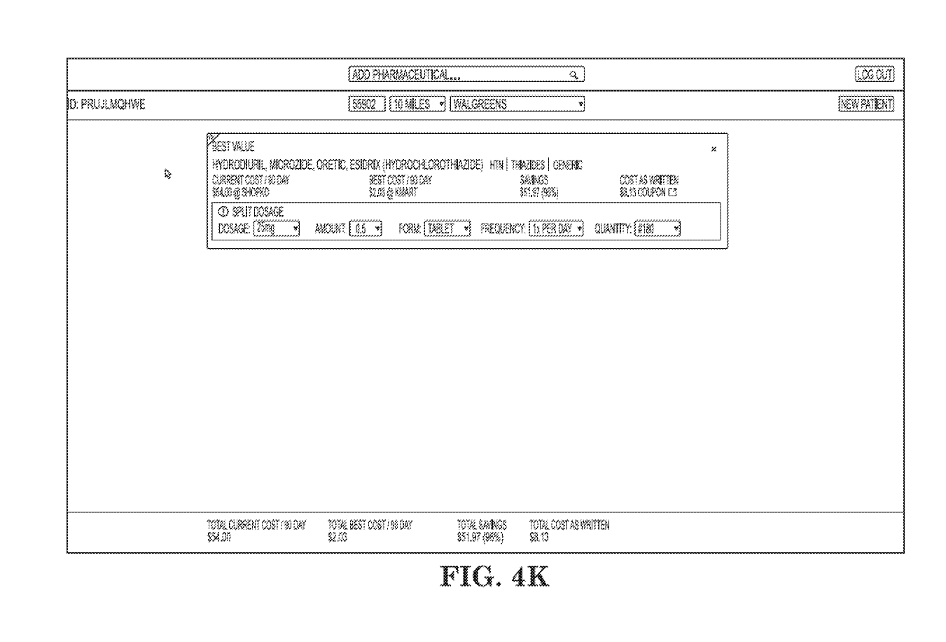

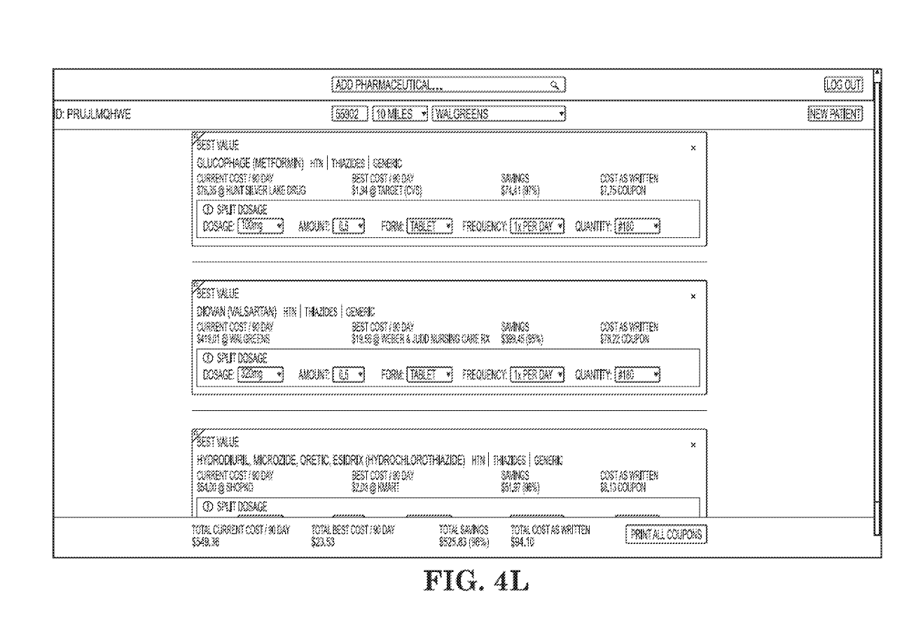

FIG. 3 is a flow chart describing embodiments of exemplary algorithms by which system 10 can be operated. The steps described in connection with FIG. 3 can be performed in other sequences or permutations in other embodiments of the invention to determine the information. During the steps described below, the processing system 20 obtains information from the databases 22, for example through application programming input (API) requests and data exchanges. FIGS. 4a-4l illustrate examples of user interfaces 12 that may be provided on the monitor 14 of the system 10, and may be used by the user in connection with the user interface 12 to input information.

Step 50: Prescription and patient information is inputted into or otherwise received by system 10. This information can, for example, be inputted by a prescribing physician (e.g., during a patient visit or afterward), or received in electronic form from another source such as the patient's electronic medical record or the provider's medical information system and automatically populated. The system 10 may provide a user interface with prompts and fields to facilitate the entry of this information (e.g., “medications,” optionally with drop-down menus). The medication information can be one or more medications as part of an as-written prescription. In other embodiments, the medication information of the prescription is added to a list or regime of other medications prescribed for the patient (e.g., prescriptions by other providers or physicians) and stored in system 10 (e.g., as part of a medical information system record for the patient).

Examples of the types of medication information that can be received by the system 10 as part of the as-written and/or other prescriptions can include the following. Some of these types of information may be included as part of an as-written prescription.

1. Medication name (“M”) (e.g., hydrochlorothiazide, chlorthalidone)

2. Number of units of the medication to be taken together (“X”) (e.g., one-half, one, two)

3. Dose of a unit of the medication (“D”) (e.g., 300 mg, 25 mg/ml, 90 mcg/puff, 2%)

4. Formulation of the medication (“T”) (e.g., aerosol, liquid, capsule, tablet, cream)

5. Frequency at which the units of the medication are to be taken (“F”) (e.g., four times/day)

6. Total number or volume of the as-written prescription (“N”) (e.g., as-written supply number or quantity of tablets or capsules, vials, pens, inhalers, supply volume of liquids [e.g. ml] or topicals [e.g. grams]). From the number N, the supply (“S”) of the as-written prescription (e.g., in terms of days) can be determined (e.g., S=N/[X*F])

Examples of the types of patient information that can be selected by the patient, prescribing physician or other user or otherwise received by the system 10 can include the following.

1. Patient's current pharmacy or pharmacies (“P”), or the location (e.g., zip code) of the pharmacy (i.e., a first or current pharmacy location)

2. Patient's residence zip code (ZipH [home]) and/or other address/location information such as the address/location of the provider (e.g., if the patient is at a provider remote from his or her residence and wants to fill the prescription near the provider's location (“ZipRx”) (i.e., a second location)

3. Limits or bounds on the distance that the patient may be able or willing to travel to fill a prescription (“ZipD”) (e.g., pharmacies near the current pharmacy, such as pharmacies within the current pharmacy zip code or within the same distance of the patient's residence as the current pharmacy and/or within a distance of the provider location)

4. Patient's insurers, providers, memberships or other information that may entitle the patient to discounts (e.g., Walgreens™, Aetna™)

5. Limits on the supply (i.e., S) for a medication (e.g., thirty days, ninety days, three-hundred and sixty-five days), pill-splitting (e.g. whether or not a patient is able to or wants to split pills), number of pharmacies to consider if patient medication list includes more than one medication (e.g. whether a patient is willing/able to go to a single pharmacy, two, three or more), fill-frequency (e.g. restricting total number of pharmacy trips per year to 10, and/or pill-burden (e.g. taking medications not more than twice a day and/or taking not more than 10 total medications per day).

In embodiments, the user interface 12 of system 10 can include labeled fields to enable entry of the patient information (e.g., “zip code,” “pharmacies,” and “distances,” optionally with selectable drop-down menus). The system 10 can also be configured to automate the data entry process.

Certain information used and determined by system 10 can be characterized generally as (1) information regarding the as-written prescription, (2) information regarding best value, and (3) information regarding alternative medications (e.g., therapeutic equivalents). This information can be provided for individual prescribed medications of an as-written prescription, all medications of an as-written prescription, and/or for groups or all of the medications of the patient's regimen. For purposes of example, the following description starts with the process by which information for an individual medication of an as-written prescription is determined, and is followed by a description of how the system 10 also provides information regarding additional medications prescribed for the patient.

As described below, a feature of embodiments of the invention is the determination of pricing for medications over a range of supply quantities. In particular, prices are determined for supply quantities different than the supply quantities of an as-written prescription. For purposes of enhancing the convenience, effectiveness and accuracy of information that is provided, and to enable effective price comparisons, system 10 rationalizes pricing information (e.g., the prices obtained if the medications are purchased at the different supply quantities) to a standardized supply period metric such as a predetermined number of days. In embodiments described below, for example, the prices determined for different supply quantities are converted to corresponding prices for 90-day supplies at the determined prices (i.e., a 90-day “supply comparison period” or “CP”). However, in other embodiments, pricing information can be converted to corresponding prices for other (i.e., greater or lesser) supply comparison periods (e.g., price per day or price for a 30 day supply).

Step 52: System 10 determines the “original” price for the medication of the as-written prescription (“Original$:AW”) at each of the patient's current pharmacy P. This original price, also sometimes referred to as the “cash” price (e.g., for patients without any form of discount [e.g., in the Summary at (c)]), is in effect the full retail price of the medication of the as-written prescription (i.e., for the as-written supply) at the patient's current pharmacy. For patients with access to a form of discount, it is the discounted price. For patients with cost sharing (e.g. flat or percentage co-pay) it is the discount price as well as subset patient cost (e.g. an insurance-negotiated discount price is $100 and the patient co-pay is $10). To enable price comparisons as described above, the original price is converted to the corresponding cost for the supply comparison period (generally, the “Original$:CP,” e.g., “Original$:90” for a ninety day comparison period). In general, Original$:CP=Original$:AW*CP/S. In embodiments, the original price for the comparison period Original$:CP can be presented (e.g., on monitor 14) as a “Current Cost/[comparison period].”

Step 54: In a manner similar to step 52, system 10 may determine a discount price or prices for the medication of the as-written prescription for the comparison period (“Discount$:CP,” e.g., “Discount$:90”) at the current pharmacies P by taking into account discounts available to the patient (e.g., due to coupons, memberships, rebates, or discounts available to insurers or providers associated with the patient). In embodiments, the discount price for the comparison period can optionally be presented (e.g., on monitor 14), for reference purposes. In other embodiments, the discount price for the comparison period is not presented to the users.

Step 56: In a manner similar to step 54, system 10 may determine discount prices for the medication of the as-written prescription for the comparison period (e.g., by taking into account available discounts) at each of one or more additional pharmacies within a distance of the patient's current pharmacy or pharmacies (“AdditionalDiscount$:CP;” e.g., “AdditionalDiscount$:90”). In embodiments, the distance used in connection with step 56 may be a distance such as ZipD selected by a user and stored in system 10. In embodiments, system 10 compares the discount prices determined during this step 56, and determines a lowest discount price for the comparison period. In effect, the lowest discount price for the comparison period represents the lowest “discounted” retail price for the medication of the as-written prescription that is available to the patient at pharmacies within the ZipD distance of the patient's current pharmacy or alternative search zip code(s) (e.g. ZipRx). In embodiments, the lowest discount price for the comparison period can be presented (e.g., on monitor 14) as a “Discount Price/[comparison period],” for reference purposes. In some embodiments, the original price for the comparison period and the discount price for the comparison period can be presented together (e.g., on monitor 14), optionally with the computed difference (e.g., in price and/or percentage) to provide reference information representative of the cost savings that can be obtained by purchasing the medication at the pharmacy associated with the lowest discount price (e.g., as “Savings”). In other embodiments, discount price information is not presented to the user.

In other embodiments, all or some of the prices determined in connection with steps 52, 54 and 56 can be presented (e.g., on monitor 14) along with the as-written prescription information (e.g., medication, dose, number of units, formulation, frequency and the as-written supply). In yet other embodiments, the presentation of this as-written prescription information can include drop-down menus or other interfaces that allow a user to change portions (e.g., dose) of that information. In these embodiments, the user can cause steps 52, 54 and 56 to be repeated if any of the information portions are changed.

Steps such as 52, 54 and 56 described above determine and provide information on the as-written prescription. This information can function as a base or benchmark for purposes of reference or comparison, and any one or more, or all, components of that information can be presented to a user. The steps described below determine and provide additional information that can be used in a comparison analysis. By such a comparison analysis based on this additional information, users may, for example, choose to write a prescription for different supply quantities and/or for different medications (e.g., therapeutic equivalents, different formulations, and/or different formulation frequency) and/or different dosing frequency and/or combinations of split-doses, combined smaller doses, and/or combination of these (e.g., having different but therapeutically equivalent doses) and/or splitting combined medications into one or more component medications and/or combining component medications into one or more combined medications and/or any permutation combination of the each of the above variables that may provide better value (e.g., cost savings) for the patient based on the patient's particular situation and circumstances.

Step 60: At step 60, system 10 determines discount prices for the medication of the as-written prescription for the comparison period, and for each of the one or more pharmacies within the ZipD distance of the patient's current pharmacy and/or alternative selected locations, as in step 58. In step 60, however, these prices are determined over a range of supply quantities in addition to the supply of the as-written prescription (i.e., range-of-supply prices). In particular, instead of making the determinations based on the as-written number N and corresponding supply S as in step 58, the determinations are made at each number N and corresponding supply S between a minimum supply Smin and a maximum supply Smax. (“SupplyDiscount$:CP,” e.g., “Supply Discount$:90”). Smin and Smax can, for example, be determined from the information input into the system 10 through the user interface 12 or otherwise received by or stored in the system; additional supply limits imposed externally (e.g. limits on controlled substance supplies) can further limit Smin and Smax. In some embodiments, system 10 determines the additional discount prices for the comparison period at each individual supply between Smin and Smax. For example, in such an embodiment were Smin is one day and Smax is three hundred and sixty-five days, system 10 will determine the discount prices for the medication at each pharmacy at each of three hundred and sixty-five daily supply quantities (which would typically include the as-written supply quantity). In other embodiments, system 10 determines the discount prices for the comparison period for the medication at each pharmacy at one or more but less than all of the supply quantities in the range. For example, in such an embodiment where Smin is one day and Smax is three hundred and sixty-five days, system 10 may determine the discount prices for the comparison period for the medication at each pharmacy at each of thirty day, sixty day, ninety day and one hundred and eighty day supply quantities. In other embodiments, the prescription may be for shorter course medications, such as those taken for fifteen or thirty days. In embodiments such as these, Smax can, for example, be fifteen or thirty days (although system 10 can search larger supplies with the intent to waste excess supply if a larger supply, even when partially wasted is more cost effective than a smaller supply). In connection with step 60, system 10 can determine the number N for each of the desired supply quantities, and access the databases 22 using the determined number N.

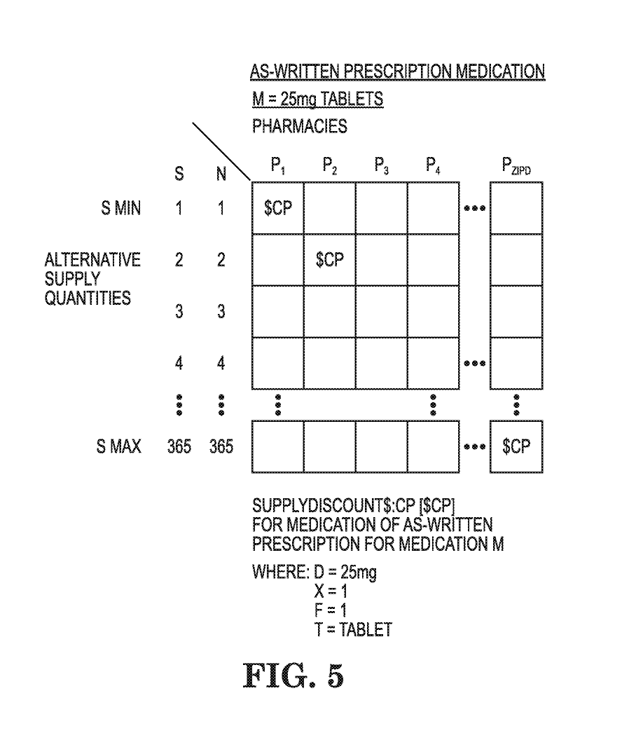

FIG. 5 is a graphical representation of a set of discount prices for the comparison period, over a range of supply quantities (i.e., SupplyDiscount$:CP) at a plurality of different pharmacies. In this example, the as-written prescription includes a medication M in the formulation of a tablet (T=tablet) having a dose D of 25 mg, that is to be taken one tablet (X=1), once per day (F=1). For purposes of this example, number N of the as-written prescription was 30 (i.e., a thirty day as-written supply S). In this example Smin is one day and Smax is three hundred and sixty-five days, so the numbers N of the corresponding alternative supply quantities are one through three hundred and sixty-five. In this example the patient's current pharmacy is designated P1, and the additional pharmacies within the ZipD distance of the patient's current pharmacy (in additional embodiments P1−PZipD are all pharmacies within a ZipD of an alternative location [e.g. ZipRx]; such additional embodiments apply to all future steps below and will therefore not be reiterated) are designated P2−PZipD. As shown, the SupplyDiscount$:CP data can be represented as a two-dimensional data set (e.g., Ns on the y-axis and Ps on the x-axis).

Although not illustrated in FIG. 5, in embodiments, system 10 can also determine the prices (i.e., for each N and for each P) for each of one or more than one pharmacy benefit manager (PBM)s, discount programs, rebates, membership programs, and/or other savings programs. In such embodiments, the data can be represented as by FIG. 5, but as a three-dimensional data set, with the prices for each discount type available in another x-y grid along the z-axis.

Step 62: At step 62, system 10 accesses databases 22 and determines whether the medication of the as-written prescription is available in alternative formulations T. If alternative formulations are available, system 10 also determines an available dose for each alternative formulation medication that is therapeutically equivalent to the dose of the medication of the as-written prescription. Continuing with the example used above, if the same medication M (that was a 25 mg tablet in the as-written prescription) is available in liquid form in a 5 mg/ml concentration, system 10 can determine an equivalent dose of 5 ml. In embodiments, this therapeutically equivalent dose determination is made based on information received by accessing databases 22.

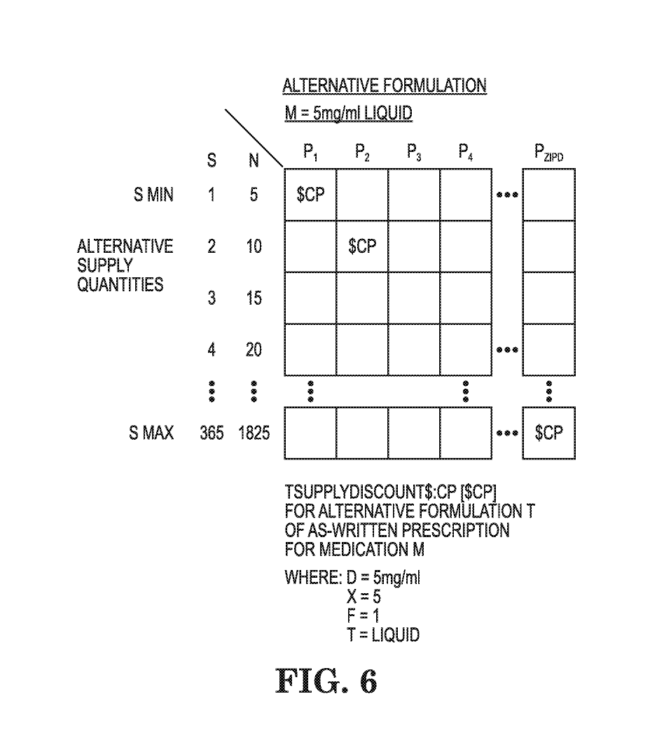

In a manner such as that described above in connection with step 60, at step 62 system 10 determines the discount prices for each alternative formulation medication of the as-written prescription for the comparison period at each of the pharmacies within the ZipD distance, and across the supply quantity between Smin and Smax (i.e., “TSupplyDiscount$:CP,” e.g., “TSupplyDiscount$:90”). In connection with this step 62, system 10 determines the numbers N corresponding to the supply quantity range, and accesses the databases 22 based on the numbers N. Continuing with the example used above, each daily supply of the alternative liquid medication is 5 ml of the medication, so the numbers N corresponding to the one to three hundred and sixty-five day supply would range from 5 ml to 1825 ml. FIG. 6 is a graphical representation of the set of discount prices for the comparison period (TSupplyDiscount$:CP), over the range of supply quantities, and at each of the pharmacies within the ZipD distance of the patient's current pharmacy. This information can be determined for each of the identified one or more alternative formulations of the medication (e.g., using the example above, the medication may also be available in 25 mg capsules). As also described above in connection with step 60, the prices TSupplyDiscount$:CP can be determined for each of one or more PBM or other available discounts. In embodiments, the user interface 12 of system 10 can include a field that allows the user to determine whether alternative formulations are allowed or not (e.g., to select “Hold Formulation” if alternative formulations should not be considered) or to limit to one or more of several formulation alternatives. By tracking and comparing the prices TSupplyDiscount$:CP, the lowest such alternative formulation discount price (and associated pharmacy) can be identified. One or more of the determined prices TSupplyDiscount$:CP, including the lowest such price, can optionally be displayed by system 10.

Step 64: At step 64, system 10 determines whether the medication of the as-written prescription, and optionally any one or more (or all) of the alternative formations of the medication of the as-written prescription that were identified in step 62, are available in an alternative dose therapeutic equivalent. In embodiments, databases 22 are accessed to identify the alternative dose therapeutic equivalents. If alternative doses are available, system 10 also determines an available dose for each alternative dose therapeutic equivalent medication that is therapeutically equivalent to the dose of the medication of the as-written prescription and any previously identified alternative formulation medications. In embodiments, this therapeutically equivalent dose determination for the alternative dose therapeutic equivalents can made based on information received by accessing databases 22.

Examples of alternative dose therapeutic equivalents that might be available and identified include (1) split unit medication dose versions of larger dose units of the medication (e.g., “splittable” medications), (2) multiple unit medication dose versions of smaller dose units of the medication, and/or (3) combined versions of (1) and (2). Continuing with the example used above, an example of a splittable alternative dose equivalent is one-half of a 50 mg tablet of the as-written prescription for the 25 mg tablet. An example of a multiple unit alternative dose equivalent of the 25 mg tablet is two 12.5 mg tablets. An example of a multiple unit alternative dose equivalent of the alternative formulation liquid medication is two and one-half ml of a 10 mg/ml liquid formulation of the medication. As an example of a combined unit alternative dose therapeutic equivalent, for an as-written prescription for a 600 mg tablet of gabapentin, the combined splittable and multiple unit equivalent can be one-half of an 800 mg tablet and two 100 mg capsules.

In a manner such as that described above in connection with step 60, at step 64 system 10 determines the discount prices for each of one or more identified alternative dose therapeutic equivalent medications of the as-written prescription (i.e., optionally including identified alternative dose therapeutic equivalent medications for each of one or more of the identified alternative formulation medications) for the comparison period at each of the pharmacies within the ZipD distance, and across the supply quantity between Smin and Smax (i.e., “ADSupplyDiscount$:CP,” e.g., “ADSupplyDiscount$:90”). In connection with this step 64, system 10 determines the numbers N corresponding to the supply quantity range, and accesses the databases 22 based on the numbers N. Continuing with the examples used above, each daily supply of the alternative 50 mg tablet would be one-half of a tablet, so a minimum of a two day supply must be purchased for Smin, and Smax requires one hundred and eighty-three tablets (N=183) where Smin, and Smax are one to three hundred and sixty-five days, respectively. Each daily supply of the 12.5 mg tablets would be two tablets, so the supply numbers N corresponding to daily supplies of Smin to Smax is two to seven hundred and thirty. Similarly, the supply numbers N corresponding to the daily supplies of Smin to Smax of one to three hundred and sixty-five days for the 10 mg/ml liquid formulation of the medication is two and one-half ml to nine hundred twelve and one-half ml.

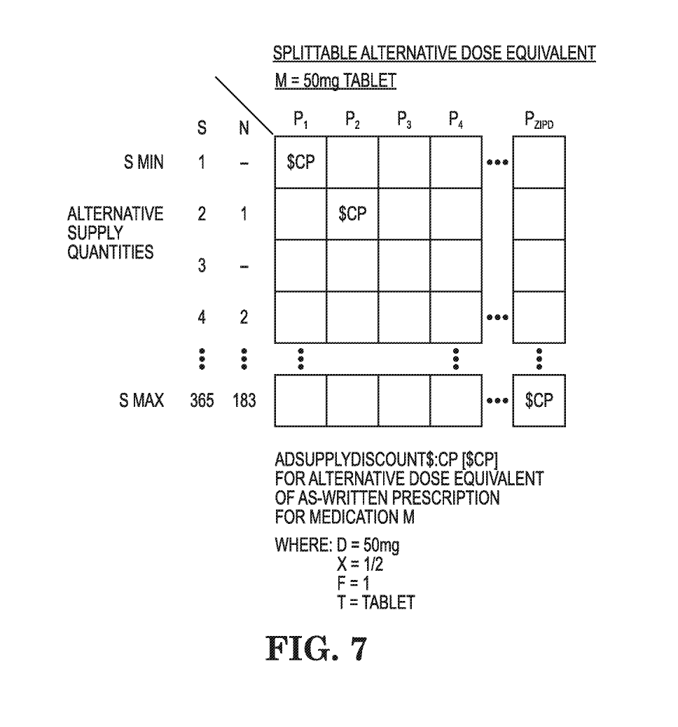

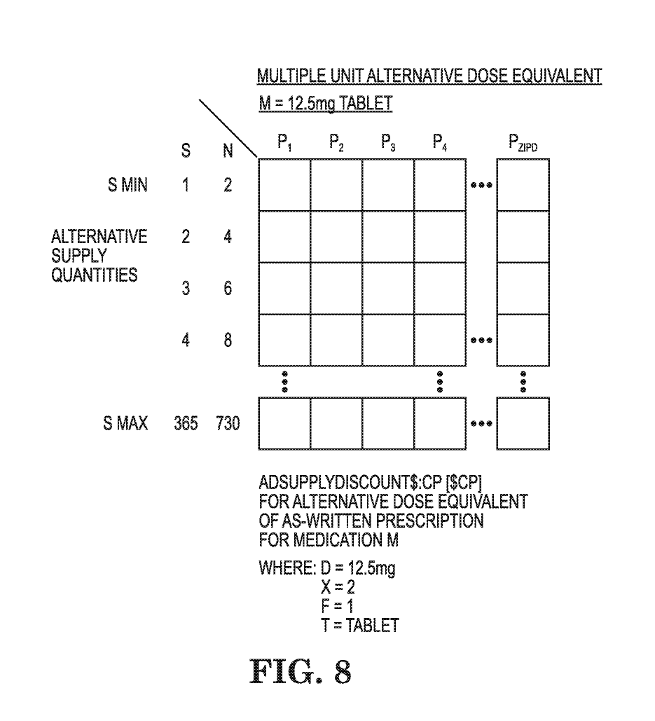

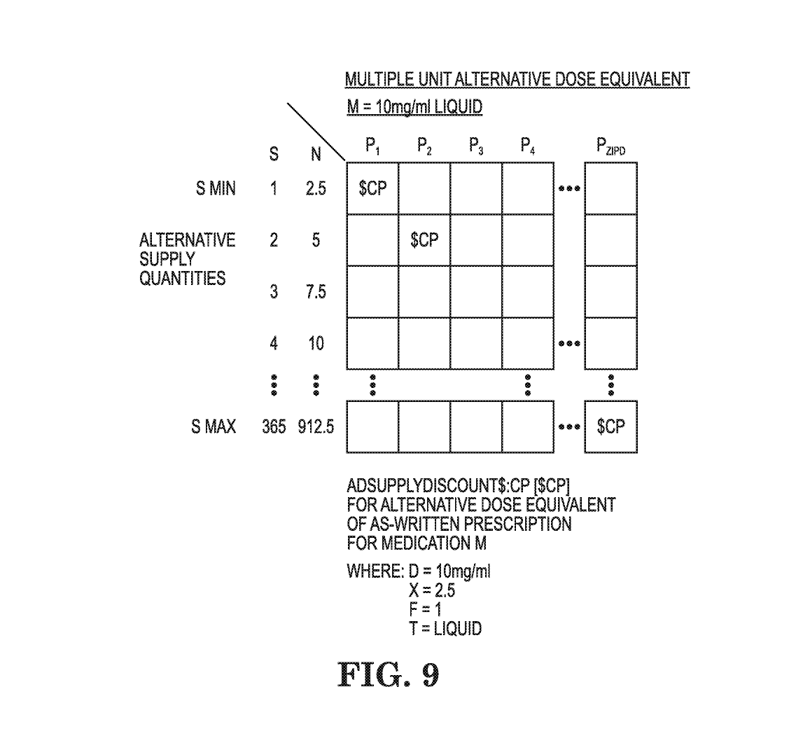

FIGS. 7-9 are graphical representations of the sets of alternative dose discount prices for the comparison period (ADSupplyDiscount$:CP), over the range of supply quantities, and at each of the pharmacies within the ZipD distance of the patient's current pharmacy, for the examples provided above. As also described above in connection with step 60, the prices ADSupplyDiscount$:CP can be determined for each of one or more available discounts. In embodiments, the user interface 12 of system 10 can include a field that allows the user to determine whether splittable or other alternative dose therapeutic equivalent medications are allowed or not (e.g., to select “No Splitting”), if alternative dose therapeutic equivalents should not be considered, and/or if additional limitations should be implemented (e.g. limiting the total number of tablets per day). By tracking and comparing the prices ADSupplyDiscount$:CP, the lowest such alternative dose therapeutic equivalent discount price (and associated pharmacy) can be identified. One or more of the determined prices ADSupplyDiscount$:CP, including the lowest such price, can optionally be displayed by system 10.

Step 66: At step 66, system 10 determines whether the medication of the as-written prescription has any generic equivalents. This determination is made, in embodiments, by accessing databases 22. In embodiments, for example, information regarding generic and branded equivalents of medications is stored in the therapeutic interchange information component 26. If one or more generic equivalents are identified, during step 66, steps 60, 62 and 64 are performed or repeated for each of the identified generic equivalents. Stated alternatively, the prices SupplyDiscount$:CP, TSupplyDiscount$:CP and ADSupplyDiscount$:CP (e.g., prices at each of the pharmacies within the ZipD distance of the patients current pharmacy, and at each alternative supply quantity within the supply quantity range of Smin to Smax) are determined for each identified generic equivalent and any alternative formulation and/or therapeutic dose equivalent combinations therein. These prices can include (1) discount prices for each of one or more (and optionally all) identified generic equivalents of the as-written medication (i.e., each a GSupplyDiscount$:CP”), and/or (2) discount prices for each of one or more (and optionally all) identified alternative formulations of each identified generic medication (i.e., each a “GTSupplyDiscount$:CP”), and/or (3) discount prices for each of one or more (and optionally all) alternative dose therapeutic equivalents of each identified generic medication of the as-written prescription medication and any combined permutations of these alternatives (collectively “GenericSupplyDiscount$:CP”). Similarly, to steps 60, 62 and 64, one or more of the lowest prices GSupplyDiscount$:CP, GTSupplyDiscount$:CP and GADSupplyDiscount$:CP for the generic equivalents (and identified pharmacies) can be identified and displayed by system 10.

Step 68: At step 68, system 10 determines whether the medication of the as-written prescription is a combination medication, and identifies the two or more corresponding therapeutic equivalent constituent or component medications. This determination is made, in embodiments, by accessing databases 22. If component medications are identified, during step 68, steps 60, 62, 64 and 66 are performed or repeated for each of the identified component medications. Stated alternatively, one or more (and optionally all) discount prices SupplyDiscount$:CP, TSupplyDiscount$:CP, ADSupplyDiscount$:CP, GSupplyDiscount$:CP, GTSupplyDiscount$:CP and GADSupplyDiscount$:CP (each of which can include one or more prices (e.g., for alternative formulations, alternative dose therapeutic equivalents and/or different generics) are determined for each identified component medication (each a “CompSupplyDiscount$:CP”). Also similar to steps 60, 62 64, and 66 one or more of the lowest prices CompSupplyDiscount$:CP for the component medications (and identified pharmacies) can be identified and displayed by system 10 and the lowest price component medications cost total can be compared to the lowest price as-written combination medication lowest price.

Step 70: Similar to step 68, system 10 determines whether any two or more individual medications of the as-written medication regimen (any medications a patient is taking) are available as a combination medication, and identifies any such combination medications. This determination is made, in embodiments, by accessing databases 22. If combination medications are identified, during step 70, steps 60, 62, 64 and 66 are performed or repeated for each of the identified combination medications. Stated alternatively, one or more (and optionally all) prices SupplyDiscount$:CP, TSupplyDiscount$:CP, ADSupplyDiscount$:CP, GSupplyDiscount$:CP, GTSupplyDiscount$:CP and GADSupplyDiscount$:CP (each of which can include one or more prices (e.g., for alternative formulations, alternative dose therapeutic equivalents and/or different generics) are determined for each identified combination medication (each a ComboSupplyDiscount$:CP”). Also similar to steps 60, 62 64 and 66, one or more of the lowest prices Combo SupplyDiscount$:CP for the combination medications (and identified pharmacies) can be identified and displayed by system 10 and the lowest price combination equivalent can be compared to the lowest price component medication cost total.

In embodiments, system 10 can perform the steps 60, 62, 64, 66, 68 and 70 as described above for any additional medications that may be a part of the patient's medication regimen. In addition, system 10 can perform the steps 60, 62, 64, 66, 68 and 70 for any or all other medications that have been prescribed and that are part of the patient's current medication regime (e.g., as reflected by the patient's electronic medical record).

System 10 can also perform the steps 60, 62, 64, 66, 68 and 70 as described above using an alternative or preferred pharmacy (i.e., P1 in the above examples). For example, the alternative pharmacy can be a pharmacy or the location of the health care provider that wrote the prescription (e.g., a destination medical center). In yet other embodiments these steps can be performed for pharmacies over extended distances (i.e., greater ZipDs from the selected location).

Stated alternatively, for each medication, all supply variations [e.g., step 60], equivalent formulations [e.g., step 62], therapeutically-equivalent dose combinations [e.g., step 64], generic alternatives [e.g., step 66], component to combination [e.g., step 68], combination to component [e.g., step 70] alternatives well described above are optimized for price including re-running each step for every permutation combination of each of these alternatives across all pharmacies within selected distances from one or more zip codes and cross referenced with available discounts for each of these permutations to find an overall best price.

In embodiments, following the determinations made in accordance with steps 60, 62, 64, 66, 68 and 70, the system 10 can determine which of the identified and priced alternatives to one or more of the medications of the as-written prescription, and/or to other medications prescribed for the patient, has the lowest price. That determined lowest price alternative (and associated pharmacy) can then be provided to the user. For example, that lowest price alternative can be identified as a “Best Value.” In other embodiments, system 10 uses other criteria to identify alternative prescription fulfillment options to provide to the user (e.g., using factors other than lowest price, such as price differences with respect to the as-written prescription prices and distances of the associated pharmacies beyond the patient's current pharmacies). The nature of the differences between the presented options and the as-written prescription can be included with the presented information (e.g., noting that the alternative is for generic, split dosage and/or different formulation medications). Two or more of the identified alternative fulfillment options can also be provided, thereby enabling health care providers and patients to weigh different factors such as price, distance and nature of alternative(s), and to determine for themselves the best option. Based on the presented information, a health care provider can write a prescription for an optimized formulation, dose, supply, and pharmacy/discount combination to enable the patient to purchase the medication at a lower cost.

As mentioned above, embodiments of system 10 can also determine the availability of therapeutic equivalents to any one or more medications of as-written prescription(s) or the patient's complete medication regimen. In embodiments, system 10 can provide a user interface feature (e.g., “Alternative Medication” tab) that can be selected by the user if the user desires to consider any such therapeutic equivalents that might be available. In other embodiments, system 10 determines these alternative medication optimized (repeating steps 60-70) prices automatically unless a user instructs the system not to take such action (e.g., if the user limits inter-class, intra-class, formula frequency, and/or some or all alternatives within each of these three alternative medication classes) through use of the user interface 12).

Step 72: If system 10 is operated to evaluate therapeutic equivalents, system 10 accesses the therapeutic interchange component 26 to identify efficacious substitutes or variations of the one or more medications. For example, therapeutic interchange component 26 can be accessed to identify different therapeutic equivalent substitute medications within the same class or different classes of the original medication, including generic and branded equivalents. The equivalent prescription or dose information (e.g., name, doses, numbers of units, formulation, and frequency) of the identified therapeutic equivalents can also be determined by system 10 (e.g., using information in the therapeutic interchange component 26). These therapeutic equivalency conversions can, for example, be done by extrapolation and conversion of total therapeutic equivalent daily doses. Disease class, therapeutic class, subclass, medication class and/or medication subclass is at times used to ensure appropriate therapeutic conversion when appropriate.

For each identified therapeutic equivalent medication, at step 72 system 10 can repeat all or portions of steps 60, 62, 64, 66, 68 and 70. By these actions system 10 can determine one or more of SupplyDiscount$:CP, TSupplyDiscount$:CP, ADSupplyDiscount$:CP, GSupplyDiscount$:CP, GTSupplyDiscount$:CP, GADSupplyDiscount$:CP, CompSupplyDiscount$:CP and ComboSupplyDiscount$:CP for each of the identified therapeutic equivalent medications (i.e., TheraSupplyDiscount$:CP, TheraTSupplyDiscount$:CP, TheraADSupplyDiscount$:CP, TheraGSupplyDiscount$:CP, TheraGTSupplyDiscount$:CP, TheraGADSupplyDiscount$:CP, TheraCompSupplyDiscount$:CP and TheraComboSupplyDiscount$:CP). Also similar to steps 60, 62, 64, 66, 68 and 70, one or more of the lowest priced therapeutic alternative medications (and identified pharmacies) can be identified and displayed by system 10. Also similar to the steps and processes described above, other information such as the nature of the therapeutic alternative medications can be displayed. This pricing information can also be determined for different “preferred” pharmacies or locations, and different distances from such preferred pharmacies.

In embodiments, any annual fees that must be paid by patients to obtain medications at a given pharmacy can be pro-rated for the period for which the cost is determined. For example, for the 90-day comparison period prices described above, any applicable annual fees can multiplied by 90/365, and included in reports as a separately identified item of information (e.g., as a “Cost as Written”).

In other embodiments, following the determination of the medication and pharmacy information described above, the information can populated into a pharmacy matrix or other report in a format usable by the users. In embodiments, for example, the reports can include columns listing information such as (1) the as-written prescription medications, (2) associated medication doses, (3) number of units of the medication taken together, (4) supply, (5) pharmacies and associated prices at the pharmacies, (6) requirements for coupons, memberships and associated costs. Any and all of the above-described determined information can be presented. For example, in embodiments the “lowest” determined costs for each pharmacy can be presented. The reports can optionally present information of this type for the patient's previous pharmacy, as well as other pharmacies determined to offer the medications at lower costs, to enable the health care provider and patient to see cost comparisons. Optionally, the reports can be highlighted or otherwise annotated to indicate factors such as (1) changes from previous reports or pharmacies used, (2) lack of changes from previous reports or pharmacies used, (3) discontinued medications, (4) prices or information that are estimates, (6) previous as-written prescriptions, (7) medications that are individual constituent substitutes of a prescribed combination medication, (8) combination medications that are substitutes of originally prescribed constituents, (9) split medications, (10) similar doses, (11) multiple smaller doses, (12) generic substitutes, (13) medication class changes. Total costs of the medications listed on the reports (e.g., from the different pharmacies) can also be included to enhance a user's (e.g., provider's and/or patient's) ability to effectively compare prices from the different pharmacies.

Relevant comorbidity and/or guideline-based prescribing information can also be obtained from databases 22 and presented in the reports. In embodiments, such comorbidity and/or guideline-based prescribing information guides substitute medications and/or recommendations determined by system 10. The comorbidity and/or guideline-based prescribing information can alternatively or in addition be presented to a provider through the user interface 12 on system 10, as well as prompts enabling the provider to provide input as to whether information such as substitutes identified by the system are acceptable in view of the identified comorbidity and/or guideline-based prescribing information.

Stated alternatively for each medication, all supply variations [e.g., step 60], equivalent formulations [e.g., step 62], therapeutically-equivalent dose combinations [e.g., step 64], generic alternatives [e.g., step 66], component to combination [e.g., step 68], combination to component [e.g., step 70], and/or inter-class, intra-class, and/or formulation frequency therapeutic alternatives [e.g., step 72] well-described above are optimized for price including re-running each step for every permutation combination of each of these alternatives across all pharmacies within selected distances from one or more zip codes and cross-referenced with available discounts for each of these permutations to find an overall best price. System 10 optimizes a patient's partial or full medication regimen for price through this process. Depending on user or otherwise defined limitations, each medication may need to be re-optimized within the constraints of the overall medication regimen (e.g. Medication A may be the lowest cost at pharmacy A when written for two 12.5 mg tablets daily, but the patient may have three additional medications which are lowest cost at pharmacy B and the user limits the number of pharmacies at which to purchase medications to a single pharmacy. If, for instance, the lowest cost way to write for medication A at pharmacy B is 25 mg daily, then the system chooses the latter option because while it is more expensive per comparison period for medication A the total medication regimen is the most cost effective per comparison period within the constraints provided).

In other embodiments system 10 filters and/or sorts the permutation results of the above described analysis to affect the variable constituents of each permutation (e.g. examples provided in numbered item 5 in the second numbered list provided under Step 50 above), re-runs all of the above analysis each time a patient refills a medication to ensure optimized price for each encounter, caches data to speed performance, and/or collects and analyses all of the above data and user input to facilitate both retrospective and predictive analysis and support.

In summary, important features of system 10 include:

1. Can be implemented at the point of prescription writing and afterward

2. Can use publicly- and privately-available medication cost data (i.e., discount programs, membership programs, insurance, PBMs, GoodRx, direct from pharmacy, etc.)

3. Looks for best price pharmacy for a single or multiple medications

4. Searches in a defined distance or distances from one or more zip codes

5. Considers altering formulation frequency (e.g. switching from 25 mg immediate-release metoprolol tartrate twice a day to 50 mg extended-release metoprolol succinate one a day)

6. Considers altering number written for

7. Considers altering medication formulation

8. Considers using multiple smaller doses

9. Considers splitting larger doses and/or combinations of 7 and 8

10. Considers switching combined medications to their constituent medications and vice versa

11. Considers intra-class therapeutic alternatives

12. Considers inter-class therapeutic alternatives

13. Uses guidelines to recommend best medication regimens

14. Takes into account comorbidities that affect medication choice

15. Considers similar doses with equivalent therapeutic benefit

16. Considers switching branded to generic and vice versa

17. Looks for best price combination of multiple pharmacies for multiple medications

18. Considers OTC alternative

19. Considers all appropriate combinations and permutations of 3-18 above.

20. Allows filtering and/or sorting the permutation results of 19 to affect the variable constituents of 3-18 to allow customized results

21. Re-optimizes medication regimens at each patient medication refill to ensure optimized price for any given encounter in time

22. Collects and analyzes user input and habits, permutation results and other data to facilitate retrospective and predictive analysis and support

Embodiments of the invention include tools such as computer systems, programmed media and methods that can be used by health care providers and others (i.e., users including institutions, physicians, pharmacists and payers such as insurance companies) to determine appropriate prescribed medication fulfillment information such as efficaciously equivalent medications and cost-effective pharmacies or other dispensing facilities tailored for individual and/or institutional users for inpatient, outpatient, or other types of medication regimens. Outputs from the tools that have this information include prescription and fulfillment information, and can be, for example, in the form of reports and visual displays. By way of example, a user such as a prescribing physician can input into the tool prescription information relating to one or more medications (i.e., an as-written prescription). In other embodiments, the prescription information can be received in an automated form (e.g., electronically from the source of the patient's electronic medical record). In response, the tool can provide reports listing pharmacies within predetermined distances of the patient's desired fulfillment location and the prices of the medications at those pharmacies. The lowest-cost pharmacies for fulfillment of the as-written prescription can thereby be determined.

In embodiments, the tools can prompt the user to request authorization before providing the alternative prescription information. The tools can be efficiently operated. The information provided by the tools can provide significant cost savings and convenience to patients and/or other payers such as insurers. Perhaps even more important, in the outpatient setting the information can reduce patient non-adherence with prescribed medication regimens, thereby improving patient outcomes and also reducing costs that might otherwise result from morbidities of such non-adherence. The tool can be used at any of a variety of physical and temporal “locations” in the health care delivery process, including, for example, at the point of prescription writing, or by a physician that is optimizing a patient's medication regimen that is the product of several prescribing physicians (e.g., based on a patient's prescription regimen determined from an electronic medical record). Best practices guidelines can be incorporated into the tools and used in connection with the generation of the reports and information. The tools can also account for comorbidities in connection the generated reports and other information.

Although the invention has been described with reference to preferred embodiments, those of skill in the art will recognize that changes can be made in form and detail without departing from the spirit and scope of the invention. For example, in embodiments, pricing for the various therapeutic alternatives can be evaluated without evaluation at the range of supply quantity prices.

1. A method for operating a computer system, comprising:
(a) receiving prescription information representative of one or more as-written prescriptions, each as-written prescription for one or more medications, wherein the prescription information includes an as-written medication name, number taken, dose, formulation, frequency and quantity for each medication of each as-written prescription;
(b) receiving supply range information representative of plurality of alternative supply quantities within a supply range, for each medication of each as-written prescription;
(c) accessing a database, based on the prescription information and the supply range information, and receiving price information including supply quantity prices for each medication of each as-written prescription for each of the alternative supply quantities, wherein the received price information includes supply quantity prices associated with each of one or more pharmacies;
(d) processing the price information to convert the supply quantity prices to common comparison period prices for each medication of each as-written prescription at each pharmacy;
(e) processing the comparison period prices to identify a low comparison period price and associated pharmacy for each medication of each as-written prescription; and
(f) providing, including optionally displaying, to a user, the identified low comparison price and associated pharmacy for each medication of each as-written prescription.

2. The method of claim 1 and including:
accessing a database based on the as-written quantity for each medication of each as-written prescription, and receiving an as-written price for each medication of each as-written prescription at each pharmacy; and
providing, and optionally displaying, to the user, the as-written price of each medication of each as-written prescription at one or more pharmacies.

3. The method of claim 1 and further including providing a graphical user interface enabling a user to select the supply range.

4. The method of claim 3 wherein:
receiving prescription information includes receiving information representative of an as-written number of units of each medication of each as-written prescription; and
receiving supply range information includes receiving information characterizing the alternative supply range quantities in terms of days of supply;
accessing the database based on the supply range information includes:
determining each alternative supply quantity within the supply range in terms of numbers of units of each medication of each as-written prescription; and
accessing the database and receiving price information based on the numbers of units of each medication of each as-written prescription.

5. The method of claim 4 wherein the accessing the database includes one or both of (1) accessing the database for supply quantities for each daily supply within the supply range, or (2) accessing the database for supply quantities at less than each daily supply within the supply range (e.g., at one or more of seven, fifteen, thirty, sixty and ninety day supply quantities).

6. The method of claim 1 wherein:
the method further includes providing a graphical user interface enabling a user to input information representative of one or both of (1) a current pharmacy, (2) a current pharmacy location, and/or (3) an alternative location; and
accessing the database includes receiving the price information associated with one or both of (1) the current pharmacy, (2) a pharmacy near the current pharmacy location, and/or (3) a pharmacy near an alternative location.

7. The method of claim 6 wherein accessing the database includes receiving the price information associated with a plurality of pharmacies within a selected distance of one or more of the current pharmacy, the current pharmacy location, and/or an alternative location.

8. The method of claim 7 wherein:
the method further includes providing a graphical user interface enabling a user to select a distance range; and
accessing the database includes accessing the database based on the selected distance range and receiving the price information associated with a plurality of pharmacies within the selected distance range of one or both of the current pharmacy, the current pharmacy location, and/or an alternative location.

9. The method of claim 1 wherein:
the method further includes accessing a database to determine therapeutic equivalent formulation medications of one or more medications of one or more of the as-written prescriptions, and optionally of each medication of each as-written prescription; and
repeating steps (b)-(f) of claim 1 in connection with each determined therapeutic equivalent formulation medication.

10. The method of claim 9 wherein:
the method further includes providing a graphical user interface enabling a user to select whether to operate the system to access the database to determine therapeutic equivalent formulation medications, and
the method does not access the database to determine therapeutic equivalent formulation medications when the graphical user interface receives a selection to not access the database to determine therapeutic equivalent formulation medications.

11. The method of claim 9 wherein:
the method further includes accessing a database to determine alternative dose therapeutically equivalent medications of one or more medications of one or more of the as-written prescriptions and/or one or more of the determined therapeutic equivalent formulation medications; and
repeating steps (b)-(f) of claim 1 in connection with each determined alternative dose therapeutically equivalent medication.

12. The method of clam 11 wherein determining alternative dose therapeutically equivalent medications includes determining alternative dose medications that are (1) split unit medication dose versions of larger dose units of the medications and/or (2) multiple unit medication dose versions of smaller dose units of the medications and/or (3) a combination of (1) and (2)

13. The method of claim 12 wherein:
the method further includes providing a graphical user interface enabling a user to select whether to operate the system to access the database to determine alternative dose therapeutically equivalent medications, and
the method does not access the database to determine alternative dose version medications when the graphical user interface receives a selection to not access the database to determine alternative dose version medications.

14. The method of claim 11 wherein:
the method further includes accessing a database to determine therapeutic equivalent generic medications of one or more medications of one or more of the as-written prescriptions; and
repeating steps (b)-(f) of claim 1 and the steps of claims 9 and 11 in connection with each determined therapeutic equivalent generic medication.

15. The method of claim 14 wherein the method further includes:
accessing a database to determine whether any two or more medications of the as-written prescriptions are available as one or more combination medications; and
repeating steps (b)-(f) of claim 1 and the steps of claims 9, 11 and 14 in connection with one or more of the determined combination medications.

16. The method of claim 15 wherein the method further includes:
accessing a database to determine whether one or more medications of the as-written prescriptions are combination medications that include two or more component medications; and
repeating steps (b)-(f) of claim 1 and the steps of claims 9, 11 and 14 in connection with one or more (and optionally each) determined component medication.

17. The method of claim 16 wherein the method further includes:
accessing a database to determine therapeutic equivalent medications for one or more medications of one or more of the as-written prescriptions; and
repeating steps (b)-(f) of claim 1, and the steps of claims 9, 11, 14, 15 and 16 in connection with each determined therapeutic equivalent medication.

18. The method of claim 17 wherein:
accessing the database to determine therapeutic equivalent medications includes converting a daily dose of each of the one or more medications of the one or more as-written prescriptions to a therapeutically equivalent daily dose of the determined therapeutic equivalent medication; and
repeating steps (b)-(f) of claim 1, and the steps of claims 9, 11, 14, 15 and 16 includes repeating the steps in connection with each determined therapeutic equivalent medication and its associated determined therapeutically equivalent daily dose.

19. The method of claim 1 and further including providing user interfaces identifying substitute medications.

21. The method of claim 19 and further including providing user interfaces prompting authorization responses to use identified substitute medications.

22. The method of claim 21 and further including receiving authorization responses to the prompts, and wherein information regarding substitute medications is not included in the reports if the authorizations are denied.

23. The method of any of claim 1 and further including accessing one or more databases to determine comorbidity and/or guideline-based prescribing information associated with the substitute medications to drive above permutation analysis, and optionally providing user interfaces associated with the comorbidity and/or guideline-based prescribing information.
